(19) United States
(12) Patent Application Publication
(10) Pub. No.: US 2006/0082192 A1
(43) Pub. Date: Apr. 20, 2006

(54) Window and sun shade module for vehicle

(76) Inventors: Steven C. Dubay, Rockford, MI (US); Darin J. Snider, Holland, MI (US); Michael J. Hulst, Holland, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/243,783

(22) Filed: Oct. 5, 2005

Related U.S. Application Data
(60) Provisional application No. 60/616,182, filed on Oct. 5, 2004.

(51) Int. Cl. B60J 7/00

(52) U.S. Cl. 296/214

(57) ABSTRACT

A window and sun shade module for a vehicle includes a frame portion configured for mounting to a vehicle, a window panel and a sun shade screen. The frame portion includes the window panel and at least one channel that extends at least partially along and generally parallel to the window panel. The sun shade screen is movable along the channel to at least partially shield the window panel when moved at least partially along the channel of the frame portion. The sun shade screen may be tracked along the window panel and may be in close proximity to the window panel when shielding at least a portion of the window panel.

### CROSS REFERENCE TO RELATED APPLICATION

The present application claims benefit of U.S. provisional application Ser. No. 60/616,182, filed Oct. 05, 2004 (Attorney Docket DON02 P-1181), which is hereby incorporated herein by reference in its entirety.

### FIELD OF THE INVENTION

The present invention relates to blinds or sun shades for vehicle windows and, more particularly, to blinds or shades that may be selectively extended or unrolled or moved to cover a portion or substantially all of a window of the vehicle to reduce glare and heat at the window.

### BACKGROUND OF THE INVENTION

It is known to provide a roll-up sun blind that is attachable to an interior portion of the vehicle, such as to an interior surface of a window of the vehicle. Such roll-up sun blinds may be provided as aftermarket devices. The roll-up sun blind or sun shade may be attached to the interior portion and the shade may be pulled to unroll the shade to cover a portion of the window. Although such roller shades work for their intended purposes, they sometimes dislodge from the interior portion during use and are often unsightly since the rollers are typically positioned on the window surface, such as via suction cups or the like, and thus are visible even when not in use. Moreover, when the roller is attached to the window surface, the window often cannot be retracted or rolled down. Also, because such roller shades are intended for use on a wide variety of windows, they often do not span the entire width of the window and thus do not reduce the glare across the entire window.

It is also known to integrate a sun blind into the vehicle trim around a window, such as into the door trim or rear package tray of the vehicle. Examples of such blinds are described in U.S. Pat. Nos. 6,422,291; 6,402,217; 6,109,330; 5,595,229; 5,291,934; 5,067,546; and 5,033,527, which are hereby incorporated herein by reference. Although such sun blinds provide a blind that may be assembled to the vehicle during vehicle manufacture, the blinds, due to the position within the vehicle or door trim, are typically spaced from the window when the window is installed in the vehicle, and thus may have a substantial thermal gap between the blind and the window, which often results in reduced thermal performance. Also, such blinds do not typically cover the entire window, particularly in back lite or rear window applications.

Therefore, there is a need in the art for a sun shade or blind for a vehicle window that overcomes the shortcomings of the prior art.

### SUMMARY OF THE INVENTION

The present invention provides a sun shade or sun blind or screen for a vehicle window. The sun shade is selectively extendable and retractable to cover and uncover the window to reduce glare and light entry through the window. The sun shade includes a screen or panel that is movable along tracks that are formed along and generally parallel to the tracks of the window, so that the sun shade screen or panel moves along or tracks the window surface and is preferably in close proximity to the window surface. The sun shade is integral with the window frame assembly, and the window and sun shade and frame may be provided as a sub assembly or module for installation in a vehicle as a unit.

According to an aspect of the present invention, a window and sun shade module for a vehicle includes a frame portion configured for mounting to a vehicle, and a sun shade screen or panel. The frame portion includes a window panel and at least one channel that extends at least partially along and generally parallel to the window panel. The sun shade screen is movable along the channel to at least partially shield the window panel when moved at least partially along the channel of the frame portion.

Optionally, the window panel may be a fixed or movable panel, and may comprise a window for a vehicle door or a vehicle sunroof or may comprise a window at a side panel of a vehicle or the like. The window panel may comprise a movable window panel that is movable along at least one second channel of the frame portion, wherein the second channel is generally parallel to the channel along which the sun shade screen is moved. The sun shade screen may be positioned and movable along a track at an interior side of the window panel and toward the interior cabin of the vehicle from the window panel, such that the sun screen may be within the vehicle and readily moved by a user irrespective of the position of the movable window or fixed window.

In one form, the sun shade screen may comprise a panel that is movable along the channel between a shielding or deployed position, where the sun shade panel is positioned at least partially along the window panel, and a retracted position, where the sun shade panel is positioned at least partially within a cavity of the vehicle (such as, for example, within a cavity of the door of the vehicle). The sun shade screen panel may substantially cover the window panel when in the shielding position, or the sun shade screen panel may partially cover the window panel when in the shielding position.

In another form, the sun shade screen may be retractable within a roller or housing portion, which may be mounted to the frame portion. The roller or housing portion may be substantially encapsulated by the frame portion so that it is not readily viewable when the module is installed in the vehicle.

Optionally, the module may include first and second sun shade screens, and the channel may comprise a first channel and a second channel positioned between the first channel and the window panel. The first sun shade screen may be movable along the first channel and the second sun shade screen may be movable along the second channel. The first sun shade screen may provide a first degree of shielding and the second sun shade screen may provide a second degree of shielding, where the first degree of shielding is different than the second degree of shielding.

Optionally, the window panel may comprise first and second window panels, and the channel may be formed along the frame portion between the first and second window panels. The sun shade screen thus may be movable along and between the window panels.

Optionally, the sun shade or screen may be moved via a motor or other drive means to adjust the extension/retraction of the screen along the window. Optionally, the motor or drive means may be operable to move the screen in response to a user input or may be automatically operable to move the screen in response to other signals or inputs, such as in response to a temperature or an ignition or gear setting of the vehicle or a glare at the window or the like.

According to another aspect of the present invention, a window and sun shade module for a vehicle includes a frame portion configured for mounting to a vehicle and a sun shade screen. The frame portion includes a window panel and opposed channel portions that extend at least partially along and generally parallel to the window panel. The sun shade screen includes a partially translucent screen portion and opposite guide portions along opposite side regions of the screen portion. The guide portions of the sun shade screen are movable along the channels to move the screen portion between a shielding position, where the screen portion is positioned at least partially along the window panel, and a retracted position, where the screen portion is not positioned along the window panel.

Therefore, the present invention provides a window and sun shade module that includes a window and a sun shade panel or screen, where the sun shade screen is movable along channels that are formed along and generally parallel to the window so that the screen is tracked along and in close proximity to the window when moved into a position at least partially along the window. The sun shade screen thus is guided along the window and is retained in close proximity to the window to provide enhanced appearance to the module and to provide enhanced temperature control. The sun shade screen may be lowered or moved into a cavity of a door or other panel of the vehicle when not in use, or may be retracted and spooled or wound around a roller of the module when not in use. The roller or housing may be positioned substantially within the module frame and thus may not be readily viewable by a person at or in the vehicle. The window and sun shade thus may be provided as an integral unit or module and may be installed as a unit to a vehicle (or to a vehicle door) along an assembly line for assembling the vehicle. Because the sun shade panel or screen may be provided as a module which includes the window panel, the sun shade panel or screen may be adapted for application with various window and vehicle designs.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle door window and sun shade, shown as installed in a vehicle door in accordance with the present invention;

FIG. 2 is a perspective view of a vehicle door window and sun shade module of the present invention;

FIG. 3 is a sectional view of the window portion and sun shade module taken along the line III-III in FIG. 2;

FIG. 4 is a perspective view of a vehicle door window and partial sun shade in accordance with the present invention;

FIG. 5 is another perspective view of a vehicle door window and partial sun shade module of the present invention;

FIG. 6 is a perspective view of a sun roof window and sun shade in accordance with the present invention;

FIG. 7 is a perspective view of another window and sun shade module in accordance with the present invention;

FIG. 8 is a perspective view of another window and sun shade module in accordance with the present invention;

FIG. 9 is a sectional view of a portion of the window and sun shade module of FIG. 7, taken along the line IX-IX in FIG. 7;

FIG. 10 is a sectional view similar to FIG. 9, showing another track portion of the window and sun shade module of the present invention;

FIG. 11 is a perspective view of another window and sun shade in accordance with the present invention;

FIG. 12 is a perspective view of another window and sun shade in accordance with the present invention, with the sun shade disposed between two window panels; and

FIG. 13 is a sectional view of the window and sun shade of FIG. 12.

### DESCRIPTION OF THE PREFERRED EMBODIMENTS

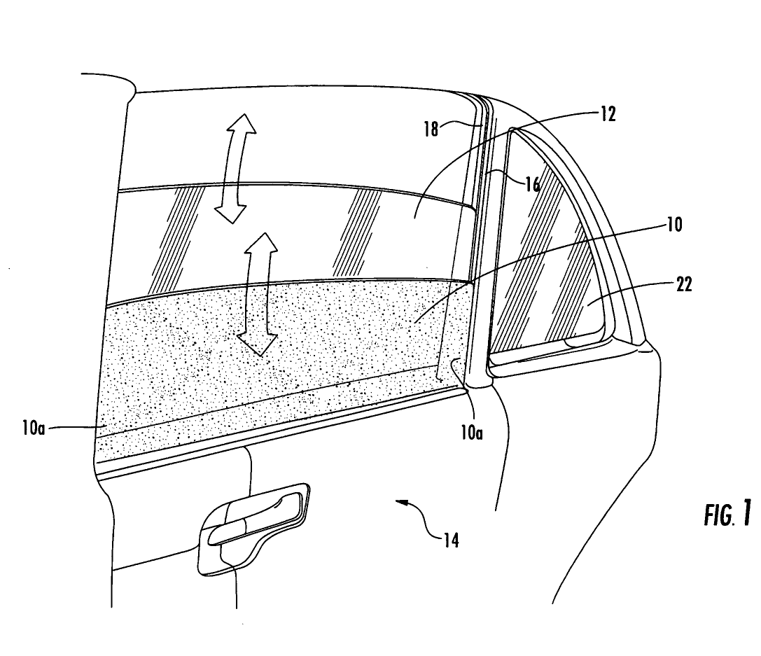

Referring now to the drawings and the illustrative embodiments depicted therein, a sun shade or blind or screen or panel 10 is movable along a window 12 of a vehicle door 14 to shield or block or reduce sun light and glare at the window 12 (FIG. 1). The sun shade 10 is movable along and generally parallel to the interior surface of the window and is guided along the window by the sides 10a of the sun shade 10 moving along a track or channel 16 formed in the window module and/or door 14. The tracks or channels 16 are generally parallel to the channel and seals 18 that guide the edges of the window 12 as it is raised and lowered, as discussed below. The sun shade thus may be integral with the vehicle door and/or window assembly and is movable along and in close proximity to the window surface to provide the desired shading or shielding of the window.

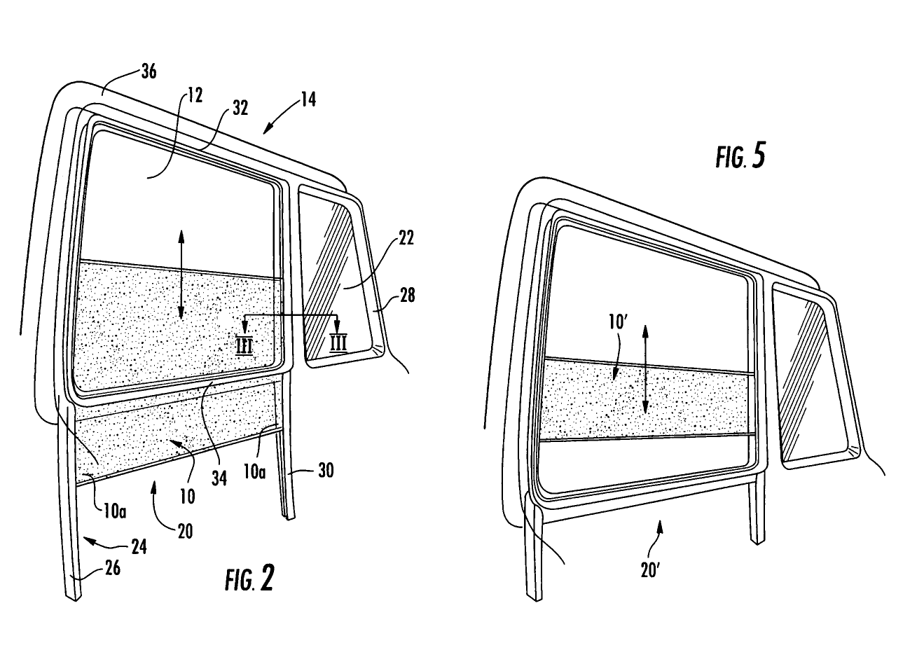

As can be seen with reference to FIG. 2, the window 12 and sun shade 10 are preferably incorporated into a window and sun shade module or assembly 20, which is mountable to the door 14 of the vehicle. The module may include the movable window and a fixed window 22, which are substantially encapsulated or surrounded by a window frame assembly 24, such as a window frame assembly of the types described in commonly assigned U.S. Pat. Nos. 6,220,650; 6,299,235; 6,394,529; 6,572,176; and 6,729,674, which are hereby incorporated herein by reference. The window frame 24 includes a front leg 26, a rear leg 28 and a divider or division leg 30, which extend between an upper member 32 and a lower member 34 and downwardly from lower member 34. The fixed window 22 may be bonded or otherwise secured to the divider 30, rear leg 28 and rear portion of the upper member 32, while the movable window 12 may be movable along channels formed in the front leg 26 and divider 30. The sides 10a of the sun shade 10 may also move along channels formed in the front leg 26 and divider 30 and thus along the window 12, as discussed below.

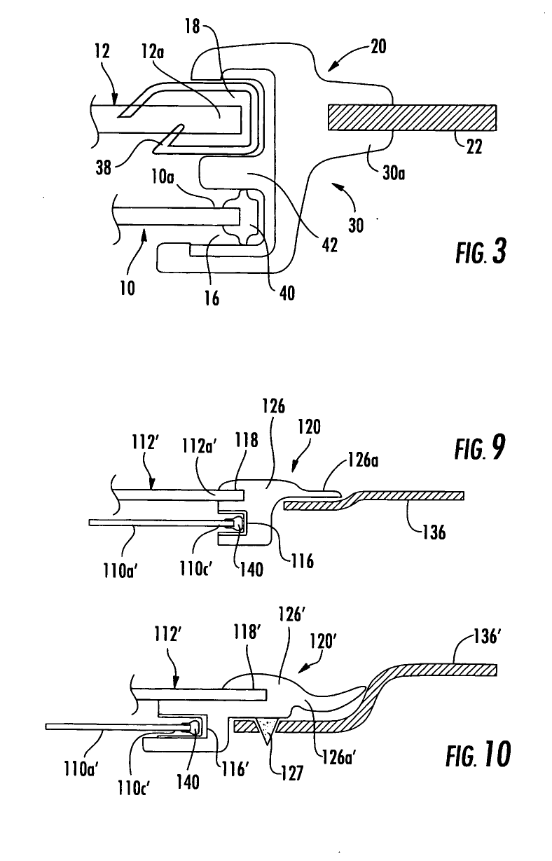

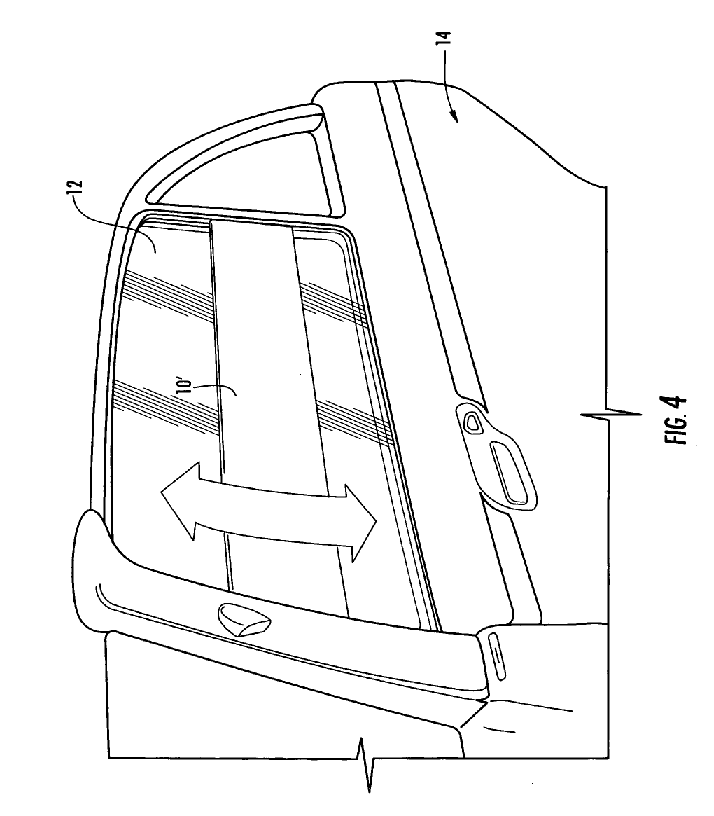

As shown in FIG. 3, the divider 30 of the frame 24 of module 20 includes a fixed window mounting portion 30a that mounts to or receives the edge or portion of the fixed window 22 of the window assembly. The divider also includes an outer channel 18 for receiving a seal 38 therein and for slidably receiving the rearward edge 12a of movable window 12. An inner channel 16 is formed in divider 30 and slidably receives the rearward edge 10a of sun shade 10. The edge 10a of sun shade 10 may include a guide member 40 therealong to guide the shade along the inner channel 16 and to retain the end or edge of the shade within the channel 16. As can be seen in FIG. 3, a channel member 42 may be received within and along divider 30 to define the inner and outer channels 16, 18. In applications without a fixed window, the divider may secure to the vehicle sheet metal of the door frame. The front leg 26 of frame 24 may be similarly formed to receive the forward edges of the window and sun shade along channels formed in the rearward side of the leg. The front and rear legs may receive or attach to the steel or sheet metal 36 of the door frame along the forward side of the front leg and rearward side of the rear leg.

The lower member 34 of frame 24 includes an opening and seal (not shown) for receiving the movable window therethrough as the movable window is raised and lowered (such as described in U.S. Pat. Nos. 6,220,650; 6,299,235; 6,394,529; 6,572,176; and 6,729,674, which are hereby incorporated herein by reference), and includes a second opening 34a inward of and generally parallel to the window opening for receiving the sun shade 10 as the sun shade is raised and lowered. When lowered to its lowered position, the sun shade may be positioned partially or substantially within the cavity of the door, and may have a grasping portion or handle portion or upper end portion for a user to grasp to raise or lower the sun shade. The grasping portion or the tracks or channels may limit downward movement of the sun shade screen within the cavity so that the grasping portion is readily accessible by a user when the sun shade screen is fully lowered (or raised or otherwise moved to the retracted or stored position) in the cavity. The sun shade may be lowered substantially into the door cavity, while the grasping portion may be at the window area and at or above the lower frame member when the sun shade is at its lowermost position, so that it is accessible by a user to grasp and pull to raise the sun shade as desired. Likewise, a lower portion of the sun shade screen may limit upward movement of the sun shade screen relative to the frame portion or vehicle, if desired.

As shown in FIG. 2, the sun shade 10 may be movable along the channels 16 of the legs 26, 30 between a raised position or shielding position, where the shade covers or shields substantially all of the window 12, and a lowered or retracted or storage position, where the shade is positioned within the door of the vehicle and substantially out of view of a person at the door of the vehicle. In the illustrated embodiment, the sun shade 10 is positioned and moved along the channels at an interior side or cabin side of the window panel. The sun shade thus may be manually moved by a user by pulling or pushing at the sun shade, such as via grasping the handle portion or the like at an upper end of the shade. The sun shade may be frictionally held in any desired position along the channels or the channels may include multiple detents positioned therealong (such as raised bumps or the like spaced along the channels to limit movement of the sun shade screen at each particular location along the channels) to retain the sun shade in different positions. Optionally, the sun shade may be moved by driving means, such as a motor or the like that is positioned within the door and that is operable to raise and lower the sun shade in response to a user input, such as a switch or button or toggle or the like at the vehicle door or elsewhere in the vehicle or at a remote signaling device, such as a key fob or the like, or in response to other inputs, as discussed below.

In the illustrated embodiment of FIGS. 1 and 2, the sun shade 10 is sized and shaped to cover or shield substantially all of the movable window 12 when the movable window and the sun shade are both in their raised positions. Optionally, and with reference to FIGS. 3 and 4, the sun shade 10′ may comprise a partial sun shade that only shields a portion of the movable window. The sun shade 10′ may be installed along the movable window 12 of the vehicle door 14 and, preferably, may be incorporated into a window and sun shade module 20′ in a similar manner as described above. In such an embodiment, the sun shade may be moved to shield the desired area of the window, and preferably may be moved downward or lowered substantially into the door cavity when not in use. The partial sun shade and/or window and partial sun shade module may otherwise be substantially similar to the sun shade and window and sun shade module discussed above, such that a detailed discussion of the partial sun shade and module will not be repeated herein.

The sun shade or screen may comprise any suitable material that is partially or substantially shielding to reduce light and heat entry through the window and into the vehicle. Preferably, the sun shade is at least partially translucent to allow some light to pass through. Such materials are known in the art of window blinds, and may include nylon and/or urethane, such as a seven layer urethane fabric or the like. However, other materials may be implemented without affecting the scope of the present invention. The sun shade material may be selected to provide the desired degree of privacy/shading at the window and may be selected to allow occupants of the vehicle to see out or through the shade while limiting others outside of the vehicle from viewing into the vehicle through the sun shade when the sun shade is deployed or positioned at the window area. The sun shade of the present invention may comprise a sheet or panel that is movable or lowerable into the door cavity and thus does not include a roller or the like, which may provide significant weight and cost savings. Optionally, however, and as discussed below, a sun shade of the present invention may include a roller or housing portion for rolling up or winding the sun shade screen.

The window and sun shade module of the present invention thus provides a sun shade or partial sun shade along a movable window (or a fixed window depending on the particular application of the sun shade module) of a vehicle door. The sun shade and window may move along the channels to the desired position, where the sun shade may provide substantial or partial coverage of the window as desired. Because the sun shade is guided along channels that are generally parallel to the window channels, the sun shade tracks to the window surface and provides an enhanced aesthetic appearance/styling of the sun shade. Also, because the sun shade or screen is in close proximity to the window when positioned along or at least partially along the window, the present invention provides enhanced temperature control, and substantially keeps the heat in and cold out (to keep the vehicle cabin warm during cold ambient temperature conditions) or substantially keeps the heat out and cooler air in (to keep the vehicle cabin cool during warm ambient temperature conditions). The position of the sun shade or screen in close proximity to the window also provides enhanced styling with minimal or no interference with the interior cabin space.

Because the sun shade is movable along the channels of the frame, and is not attached to the window panel, the sun shade may be moved irrespective of a position of the movable window panel, so that the sun screen may be used even when the movable window panel is lowered or partially lowered or opened. When the shading provided by the sun screen is not desired, the sun shade may be lowered or raised or otherwise moved away from the window opening (such as into the door frame area below the window opening or into a vehicle cavity above or below or to the side for a side window or rear window or the like or into a ceiling area at a side or end of a sun roof window opening or the like) so as to be substantially or entirely not viewable by an occupant of the vehicle when the sun shade or screen is not in use. Also, the window, sun shade and frame preferably is incorporated into a window and sun shade module and the module may be readily installed as an integral unit to the vehicle door at a vehicle assembly plant.

Although shown and described as being installed at a vehicle door, it is envisioned that the sun shades and/or window and shade modules of the present invention may be applicable to other windows or doors (such as a rear door or rear side portion or tailgate) of a vehicle, such as a fixed window along a side panel or rear door of a vehicle or such as a sun roof along a roof of a vehicle, without affecting the scope of the present invention. Multiple sun screens at different windows of the vehicle may be extended/deployed to limit viewing of the cabin of the vehicle, such as when the vehicle is parked, so as to substantially limit viewability of the contents of the vehicle by a person outside of the vehicle.

Optionally, the sun shade screen may comprise a stretchable or deformable screen material that may be stretched or formed to span a wider portion of the window opening (such as at a lower portion of a window opening at a side of a vehicle or the like) and may compress or retract to remain substantially or at least partially taut at a narrower portion of the window opening (such as at an upper portion of a window opening where the window panel may be a generally triangular shaped window panel or the like) as the sun shade screen is moved or extended toward the narrower portion (or the sun shade screen may be at an initial taut state at the narrower region or portion and may stretch as the sun shade screen is moved toward the wider region or portion of the window opening of the frame portion). The sun shade screen thus may substantially or entirely span the width or cross dimension of the window opening of the frame portion of the sun shade module throughout the entire range of motion of the sun shade screen.

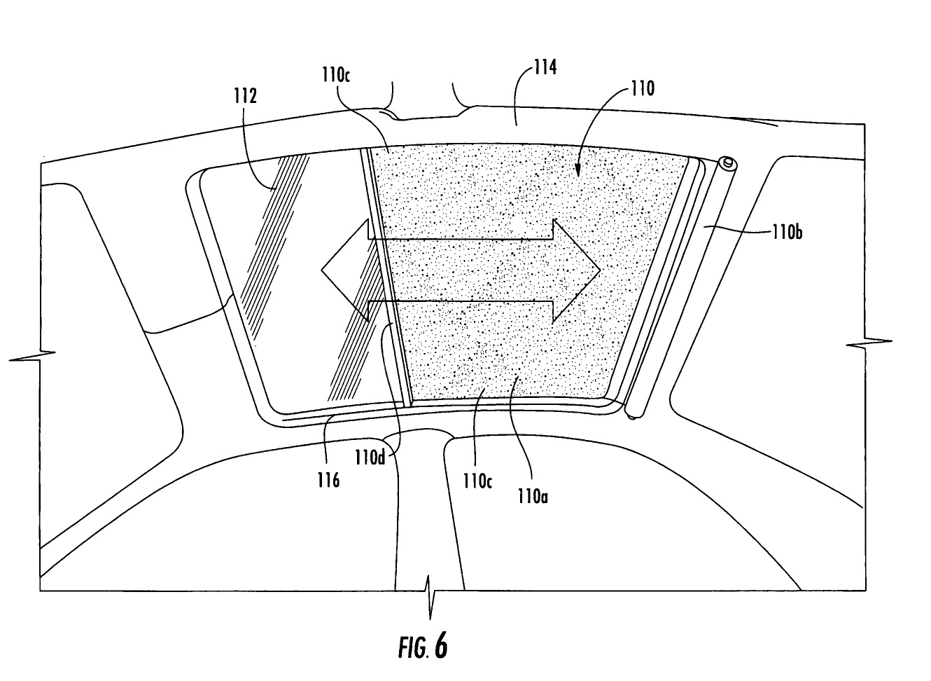

Referring now to FIG. 6, a sun shade 110 includes a flexible membrane or panel or screen 110a and a roller portion or housing 110b that rolls up and unrolls the flexible screen or membrane, such as is known in the art. The roller 110b is mounted to a roof portion 114 of a vehicle and the sun shade panel or screen 110a is extendable to cover or shield or partially shield a sun roof or window 112 of the vehicle. The sides or edges 110c of the sun shade panel are guided and supported along channels 116 formed along the roof portion and generally parallel to and in close proximity to the window surface, such that the sun shade panel tracks along the window surface when at least partially extended from the roller portion 110b. The sun shade panel 110a may include a grasping portion or handle portion 110d at an end thereof to assist a user in manually extending and retracting the sun shade panel along the window (such that the sun shade may be readily extended/retracted or deployed/stored by a user within the vehicle, either when the vehicle is moving or parked). The roller portion may be biased to retract the sun shade panel, and the frame portion may include a latching mechanism to retain the sun shade panel in its fully extended position. Optionally, the channels may include one or more detents or the like positioned therealong for retaining the sun shade panel at a desired location or degree of extension along the window. Optionally, the sun shade panel may be retracted by a user pushing or moving the sun shade or handle toward the roller portion, or the sun shade panel may be electronically controlled via a motor or the like that is responsive to a user input or in response to other inputs (as discussed below), without affecting the scope of the present invention.

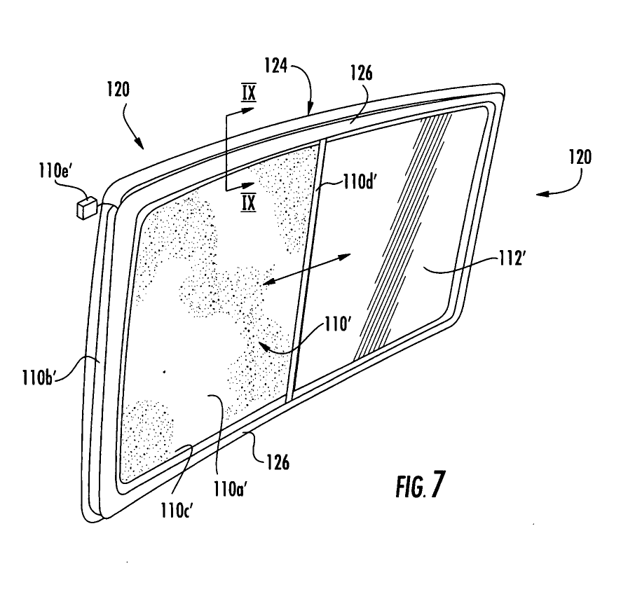

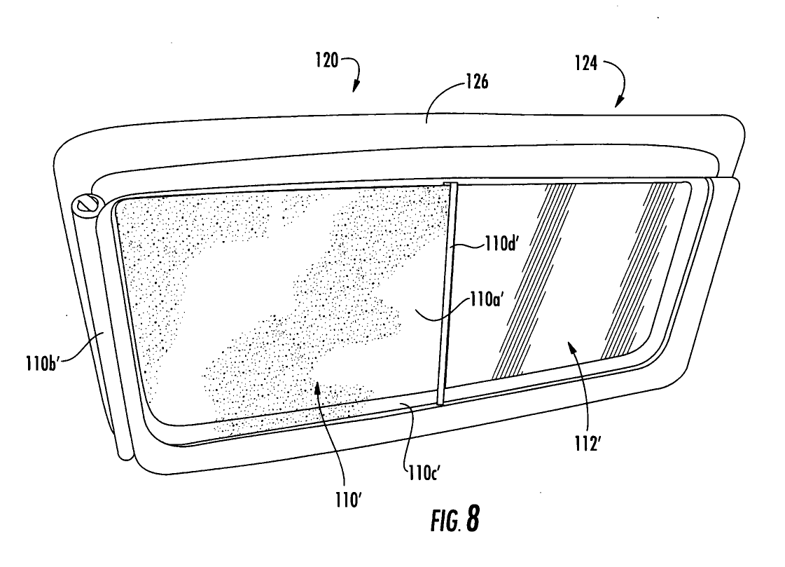

Optionally, and with reference to FIGS. 7 and 8, the sun shade 110′ and window 112′ may be incorporated into a window and sun shade module 120, which may be readily installed as an integral unit in an opening in the vehicle roof or sidewall or door or the like, depending on the application of the module. As shown in FIG. 9, the module 120 includes a frame 124 having a pair of side members 126, each of which includes a mounting portion 126a for engaging and sealing or attaching to the sheet metal or steel 136 or the like of the vehicle. The side member 126 includes an outer channel 118 for receiving and retaining an edge portion 112a′ of the window 112′ and an inner channel 116 for receiving and supporting and guiding a guide member 140 at an edge or side 110c′ of the sun shade panel 110a′. The module may include other forms of side members and channels and mounting portions, depending on the particular application of the window and shade module of the present invention. For example, and with reference to FIG. 10, the window and sun shade module 120′ may include a mounting portion 126a′ along a side member 126′, with one or more fasteners 127 for securing the module to the sheet metal 136′ of the vehicle. The outer channel 118′ may be formed to receive the edge of the fixed window 112′, while the inner channel 116′ receives the guide member 140 of the edge portion 110c′ of shade panel 110a′, such as in a similar manner as described above.

The sun shade screen or panel 110a′ thus may be guided along the inner surface of the window and in close proximity to the window to provide enhanced appearance and functionality to the sun shade. The roller or housing portion 110b′ of the sun shade 110′ may attach to or snap to an end portion of the window and shade module. In the illustrated embodiments of FIGS. 7 and 8, the roller portion may be substantially encapsulated or encased or at least partially concealed within a portion of the module frame, so that it is not readily viewable by a person within the vehicle.

The sun shade panel or screen thus may be extended and retracted along the fixed window panel via moving the guide members along the channels that are generally parallel to the window panel edges. The sun shade panel may include a grasping portion or handle portion 110d′ at an end thereof to assist a user in manually extending and retracting the sun shade panel along the window and module. The roller portion or housing may be biased to retract the sun shade panel, and the frame portion may include a latching mechanism and/or the channels may include one or more detents or the like for retaining the sun shade panel at a desired location or degree of extension along the window. Optionally, the sun shade panel may be retracted by a user pushing or moving the sun shade or handle toward the roller portion, or the sun shade panel may be electronically controlled via a motor or the like, without affecting the scope of the present invention. Optionally, the window panel may be movable, such as tiltable or slidable relative to the frame portion, to allow for opening or partially opening the window of the window and sun shade module, without affecting the scope of the present invention.

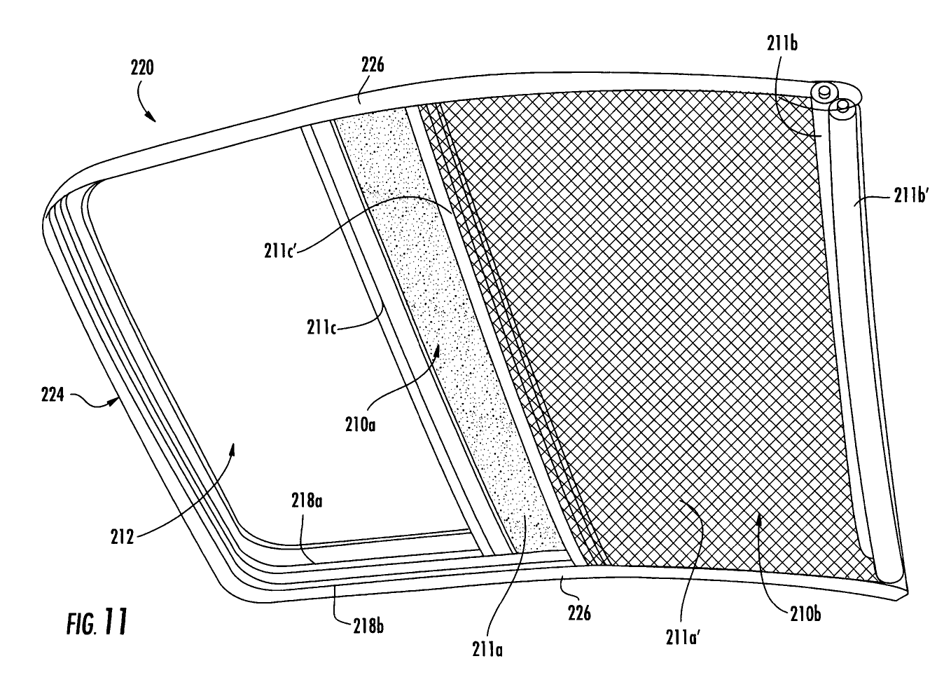

Optionally, a sun shade or window and shade module of the present invention may include two sun shades, with one sun shade screen or panel or membrane being less translucent than the other screen or panel, in order to provide different degrees of shading or shielding at the respective window. For example, and with reference to FIG. 11, a window and sun shade module 220 includes a first sun shade 210a and a second sun shade 210b positioned at a window 212. Each sun shade 210a, 210b includes a flexible sun shade screen or panel or membrane 211a, 211a′ and a roller or housing portion 211b, 211b′, respectively. The module 220 includes a frame portion 224 that includes side members 226 that receive or are secured to window panel 212, and that have a pair of channels 218a, 218b extending along and generally parallel to the window panel 212. The first sun shade 210a may be positioned above the other shade 210b (or otherwise closer to the window panel than the other sun shade) and adjacent to or in close proximity to the window panel 212, whereby the sides or edges of the sun shade panel 211a of sun shade 210a may be guided and supported along the outer or upper channels 218a, while the sides or edges of the sun shade panel 211a′ of the other sun shade 210b are guided and supported along the lower or inner channels 218b, such as in a similar manner as described above. The roller or housing portions may readily attach to or snap to the frame of the window and sun shade module, whereby the sun shade panels are generally aligned with and received in the respective channels along the side frame members.

Preferably, the sun shade panels or screens of the sun shades provide a different degree of shielding at the window so that a user may selectively move one of the screens along the window to provide the desired shielding. For example, one of the screens (such as the screen 211a of sun shade 210a) may comprise a substantially opaque material (particularly for applications on sunroof of a vehicle), and may be selected to generally or substantially match the material of the headliner of the vehicle (for applications at a sunroof or moonroof of the vehicle) to provide an enhanced aesthetic appearance of the window when the opaque screen is positioned at the window. The other screen may provide reduced shielding or solar tinting (and/or increased transparency or translucency) relative to the substantially opaque screen. For example, the screen 211a of sun shade 210b may comprise a flexible web or screen material formed of nylon and/or urethane, such as a seven layer urethane fabric or the like. However, other materials and other degrees of shielding may be selected for either or both screens, without affecting the scope of the present invention. Although shown and described as a sunroof and sun shade module, the dual sun shade arrangement may be implemented with a side window or rear window or front windshield or the like of a vehicle without affecting the scope of the present invention. It is further envisioned that the dual screen aspects may be applicable to non-rolled sun shade screens or panels such as sun shade screens 10, 10′ discussed above, where two screens may be selectively raised and lowered along or partially along and over the movable window of a vehicle door.

The sun shade screens 211a, 211a′ may include a grasping member or portion or handle 211c, 211c′ at an end thereof to assist a user in opening/extending and closing/retracting the screens. Optionally, the screens may be moved or extended or retracted via an actuating or driving device, such as a motor or the like, without affecting the scope of the present invention. The control or motor or the like may be operable in response to a user input, such as a button or switch or the like, positioned at the window and sun shade module or positioned elsewhere in the vehicle (or via a signal from a remote device, such as a remote keyless entry device or key fob or the like), or may be automatically deployed or retracted in response to other inputs, as discussed below.

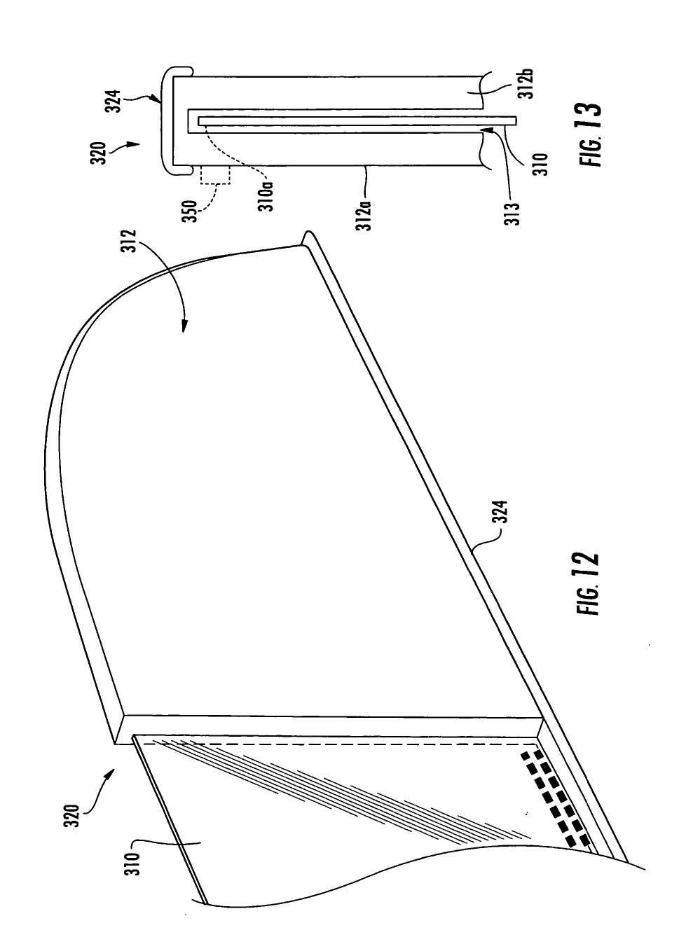

Optionally, and with reference to FIGS. 12 and 13, a window and sun shade module 320 includes a frame portion 324, a window portion 312 and a sun shade panel or screen 310. The window portion 312 includes first and second window panels 312a, 312b that are spaced apart from one another and define an interspacing cavity 313 therebetween. The sun shade or screen or microblind 310 is movable along the frame portion 324 (such as along a channel or channels formed in the frame portion and between the window panels) and between the window panels to shield or reduce transmission of light and heat through the window panels.

The sun shade screen 310 may be movable between a retracted position, where the screen may be substantially removed from the cavity between the window panels, and an extended or shielding position, where the screen may be positioned substantially along and between the window panels. When in the retracted position, the sun shade screen may be positioned within a cavity of the vehicle, such as within a cavity of a door or side wall or roof of the vehicle, or may be wound around a roller portion or housing portion positioned adjacent to the window panels and module.

Optionally, the sun shade screen 310 may be movable between the extended and retracted positions via a motorized device or driving means or the like, such as in response to a user input, or may be manually movable by a user of the sun shade, without affecting the scope of the present invention. For example, the sun shade screen 310 may include a magnetic portion or strip or element 310a, and the module 320 may include a magnetic slide or member 350 (FIG. 13). A user may move or slide the magnetic member 350 along the surface of the interior window panel 312a, whereby the sun shade screen 310 may correspondingly move via the magnetic attraction between the magnetic member 350 and the magnetic portion 310a of sun shade screen 310. Other means for moving the sun shade screen along and between the window panels may be implemented, without affecting the scope of the present invention.

Although shown and described as having a single shade or screen that is movable along the window, it is envisioned that one or more screens may be provided at or with a window and sun shade module in accordance with the present invention. Optionally, for example, a roller (or pair of rollers for a dual shade application) may be mounted or positioned at one end of a window and sun shade module, and another roller (or pair of rollers for a dual shade application) may be mounted or positioned at the other end of the module. The screens may be extended or deployed from the respective rollers to cover a respective portion of the window panel. Optionally, the screens may come together and engage or latch together at a generally center region of the window to hold the screens in their fully extended position. Such an embodiment allows for reduced sized rollers/housings of the respective shades, since each screen may be smaller than a single screen that covers the entire window. Also, such an embodiment provides the ability to cover panoramic roofs, where the rear seat of the vehicle may be covered by the screen extending from the roller at one end of the module, while the front seat may be covered by the screen extending from the roller at the other end of the module. Optionally, two screens or shade panels may be positioned at opposite ends and extended from a respective cavity in the vehicle panel at a respective end of the window and sun shade module, such that the screens may be retracted within the respective cavities (such as in a similar manner as described above with respect to sun shades 10, 10′), and extended therefrom to cover a respective portion of the window panel, without affecting the scope of the present invention. One of two different types of screens may be extended to provide a desired degree of shading and/or two different types of screens may be extended and overlapped to provide an enhanced degree of shading if desired. Such types of screens, number of screens and ability to abut or overlap two or more screens may be selected depending on the particular application of the sun screen module and the characteristics and features desired by the vehicle manufacturer or owner of the vehicle.

Although shown at side or door windows and/or at a sunroof of a vehicle, the window and sun shade modules of the present invention may be implemented at other vehicle windows, such as at a vehicle windshield or rear window or the like. The sun shades or screens may be extended and/or retracted to cover/uncover the respective window, either manually or electronically or automatically, such as in response to a user input or other input or control. The type of operation or extension/retraction of the sun shade or shades may be selected depending on the particular application and desired characteristics of the sun shade and vehicle in which it is incorporated.

Optionally, the sun shade or screen may be automatically deployed or retracted via an electronic motor or drive means (such as a motor or driving means 110e′ in FIG. 7) in response to an input from a user and/or a sensor or the like. For example, the drive means may automatically deploy a sun shade at a window or sunroof or windshield of the vehicle in response to a temperature or sun load or glare at the window, such as may be detected or sensed via a temperature sensor or photo sensor or sun load sensor, which may be positioned at the window and interiorly of the sun shade screen. The drive means may fully deploy and/or partially deploy the sun shade depending on the detected temperature or glare or sun load at the window. Optionally, such a temperature sensor or photo sensor or sun load sensor may be positioned elsewhere within the vehicle, such as at an interior rearview mirror assembly of the vehicle or the like. The drive means may automatically deploy/retract the sun shade during operation of the vehicle and/or when the vehicle is parked.

Optionally, the sun shade or shades may be automatically deployed and/or retracted in response to other inputs. For example, a sun shade at a rear window of a vehicle (and/or other sun shades at other windows of the vehicle) may be automatically retracted in response to the vehicle shifting into reverse, in order to enhance the rearward viewing by the driver of the vehicle while backing up. Optionally, a sun shade at the windshield of the vehicle (and/or other sun shades at other windows of the vehicle) may be automatically deployed when the vehicle is shifted to park or when the ignition is turned off, so that the sun shade is deployed when the vehicle is parked. The sun shade may be automatically retracted when the ignition is turned on (or when the vehicle is shifted to drive or reverse or the like).

Optionally, the sun shade at each window may be independently controlled (such as automatically or in response to a user input or the like, such as by independent switches or toggles or buttons at the driver area of the vehicle, such as by or near the window controls or the like), or may be controlled together, such as automatically or via a single switch or toggle or button at the driver area of the vehicle. The driver thus may deploy or retract some or all of the shades together (such as a “family” of shades that includes the side windows or rear passenger door windows or the like) when parking the vehicle or the like (or may deploy the shades at the side windows together, while having independent control of other shades at other windows of the vehicle). Optionally, a user input may be positioned at each window to allow for independent control of the sun shade at that window, so that a person sitting at a side window may deploy or retract their sun shade while the others are retracted or deployed by a common control. Such an override feature allows the driver to deploy or retract multiple sun shades via a single control, while allowing a passenger to set the sun shade to a desired position at the window nearest to the passenger. Optionally, the sun shade or shades may be deployed or retracted via a remote control device, such as a user input on a remote keyless entry device or key fob or the like, so that the vehicle owner or user may extend or retract the sun shade or shades from outside of the vehicle if desired.

Optionally, the sun shade screens may be substantially uniform in color and appearance over substantially the entire viewable surface of the sun shade screen when it is deployed. The material of the sun shade screens may be selected to provide a desired degree of solar tinting or shielding or shading, along with the desired appearance and flexibility for the particular application. The material may comprise a continuous sheet or membrane or may comprise a screen or web type of membrane with openings or holes to let light pass therethrough, without affecting the scope of the present invention.

Optionally, the sun shade may comprise a customized or personalized sun shade, and may include a customization or personalization affect thereon, such as a texture or logo or color or icon or the like printed or screened or molded or otherwise formed on the sun shade screen or panel, to provide a personalized sun shade that is personalized or customized for the particular owner of the vehicle or the vehicle manufacturer or sun shade manufacturer or the like. For example, the sun shade screen or panel may be printed or screened or otherwise affected to provide the letters “FORD” or a pattern or logo similar to the design or designs indicative of the manufacturer, such as the Chevrolet “bowtie” or the like. Optionally, other designs or patterns or text or logos or indicia or the like may be provided at or formed on the sun shade screen or panel to provide a desired image or logo, so as to be indicative of, for example, other vehicle manufacturers or entities or sponsors or indicia or trademarks or emblems or signature items, or representations of certain political views, religious beliefs, tribal affiliations, community ties, collegiate affiliations, allegiances and/or advocacy (such as, for example, a “peace” sign or other symbol or text or the like) or other views, affiliations, beliefs, etc., without affecting the scope of the present invention.

The desired image or logo may be indicative of the vehicle manufacturer, or may be selected by the user or vehicle owner to provide a customized sun shade (or sun shades), without affecting the scope of the present invention. For example, a person may select the logo or mascot of their alma mater to be printed on the sun shade screen to customize the sun shade for that particular person or owner. For example, the sun shade screen or panel may include a school logo and colors, such as, for example, the letters “MSU” in green and white print/background, to provide a desired appearance to the personalized sun shade or shades for a particular consumer, such as, for example, a student or graduate of Michigan State University. Optionally, the sun shade screen or panel may include other text or logos or brand names or other types of identifying indicia, such as, for example, “FORD” to identify the vehicle manufacturer, or “TOMMY HILFIGER” to identify the vehicle owner's clothing preference or the like, or other text or messages or images or trademarks or colors or patterns or indicia or the like to provide a desired appearance or identification or message or statement or advertisement or logo or sponsorship identification or style or brand identification on the sun shade screen or panel. Other forms of customized logos or indicia or the like may be printed or otherwise formed at the sun shade screen or panel, without affecting the scope of the present invention. The window and sun shade module may thus be assembled or formed to have the desired or personalized sun shade screen or panel with the desired or personalized logo or color or message or indicia thereon to provide the desired or personalized finish or appearance of the sun shade or shades.

Therefore, the present invention provides a window and sun shade module that includes a window and a sun shade panel or screen. The sun shade screen is movable along channels that are formed along and generally parallel to the window panel so that the sun shade screen is tracked along and in close proximity to the window panel when moved into a position at least partially along the window panel. Such tracking of the sun shade along the window is accomplished by the present invention for substantially flat or planar window panels and for curved window panels. The sun shade screen thus is guided along a flat or curved window panel and is retained in close proximity to the window panel to provide enhanced styling/appearance to the module and to provide enhanced temperature control and reduced heat load. The sun shade screen may be lowered or moved into a cavity of a door or other panel or portion of the vehicle when not in use, or may be retracted and spooled or wound around a roller of the module when not in use. The roller or housing may be positioned substantially within the module frame and thus may not be readily viewable by a person at or in the vehicle.

The sun shade of the present invention is incorporated into a window and frame assembly or module to provide a unitary or integral module or sub-assembly. The integral window and sun shade module may be readily installed to a vehicle as an integral unit as the vehicle is moved along a vehicle assembly line. The sun shade module of the present invention thus provides a modular window and sun shade assembly or module and reduces part number proliferation and assembly processes and costs at the vehicle assembly plant or facility. The modular sun shade and window assembly of the present invention may provide enhanced packaging flexibility to accommodate different window and vehicle designs, without adversely affecting the assembly plant processes at the vehicle assembly plant or facility. The present invention thus provides a sun shade and window module that is installable with reduced labor at the vehicle assembly plant, since the module is installed as a unit at the vehicle assembly plant.

Changes and modifications to the specifically described embodiments may be carried out without departing from the principles of the present invention, which is intended to be limited only by the scope of the appended claims as interpreted according to the principles of patent law.

What is claimed is:

1. A window and sun shade module for a vehicle, said window and sun shade module comprising:
a frame portion configured for mounting to a vehicle;
said frame portion including a window panel;
said frame portion including at least one channel that extends at least partially along and generally parallel to said window panel; and
a sun shade screen, said sun shade screen being movable along said at least one channel to at least partially shield said window panel when moved at least partially along said at least one channel.

2. The window and sun shade module of claim 1, wherein said sun shade screen includes a guide portion along at least one edge region of said sun shade screen, said guide portion being at least partially received in said at least one channel to guide said sun shade screen at least partially along said at least one channel.

3. The window and sun shade module of claim 1, wherein said sun shade screen includes a grasping portion along an edge region of said sun shade screen, said grasping portion being configured for a user to grasp to move said sun shade screen along said at least one channel.

4. The window and sun shade module of claim 1, wherein said window panel comprises a movable window panel that is movable along at least one second channel of said frame portion.

5. The window and sun shade module of claim 1, wherein said window panel comprises a fixed window panel that is substantially fixed relative to said frame portion.

6. The window and sun shade module of claim 1, wherein said sun shade screen comprises a flexible screen that is movable along said at least one channel between a shielding position, where said flexible screen is positioned at least partially along said window panel, and a retracted position, where said flexible screen is positioned at least partially within a cavity of the vehicle.

7. The window and sun shade module of claim 6, wherein said sun shade screen substantially covers said window panel when in said shielding position.

8. The window and sun shade module of claim 6, wherein said sun shade screen partially covers said window panel when in said shielding position.

9. The window and sun shade module of claim 1, wherein said sun shade screen is retractable within a housing portion, said housing portion being mounted to said frame portion.

10. The window and sun shade module of claim 9, wherein said housing portion is substantially encapsulated by said frame portion.

11. The window and sun shade module of claim 1 including a second sun shade screen, said at least one channel comprising at least one first channel and at least one second channel positioned between said at least one first channel and said window panel, said sun shade screen being movable along said at least one first channel and said second sun shade screen being movable along said at least one second channel.

12. The window and sun shade module of claim 11, wherein said sun shade screen provides a first degree of shielding and said second sun shade screen provides a second degree of shielding, said first degree of shielding being different than said second degree of shielding.

13. The window and sun shade module of claim 1, wherein said window panel comprises first and second window panels and said at least one channel is positioned between said first and second window panels.

14. The window and sun shade module of claim 1, wherein said window panel comprises a sun roof of the vehicle.

15. The window and sun shade module of claim 1, wherein said window panel comprises a window of a door of the vehicle.

16. A window and sun shade module for a vehicle, said window and sun shade module comprising:
a frame portion configured for mounting to a vehicle;
said frame portion including a window panel;
said frame portion including at least one channel that extends at least partially along and generally parallel to said window panel, said at least one channel being at an interior side of said window panel and toward an interior cabin of the vehicle when said frame portion is mounted to the vehicle; and
a sun shade screen, said sun shade screen comprising a flexible screen that is movable along said at least one channel between a shielding position, where said flexible screen is positioned at least partially along said window panel to at least partially shield said window panel, and a retracted position, where said flexible screen is positioned at least partially within a cavity of the vehicle.

17. The window and sun shade module of claim 16, wherein said window panel comprises a movable window panel that is movably mounted to said frame portion and that is movable along at least one second channel of said frame portion.

18. The window and sun shade module of claim 16, wherein said window panel and said frame portion and said at least one channel are curved.

19. The window and sun shade module of claim 16, wherein said sun shade screen is retractable within a housing portion, said housing portion being substantially encapsulated by said frame portion.

20. The window and sun shade module of claim 16, wherein said sun shade screen includes a guide portion along at least one edge region of said sun shade screen, said guide portion being at least partially received in said at least one channel to guide said sun shade screen at least partially along said at least one channel.

21. The window and sun shade module of claim 16, wherein said sun shade screen includes a grasping portion along an edge region of said sun shade screen, said grasping portion being configured for a user to grasp to move said sun shade screen along said at least one channel.

22. A window and sun shade module for a vehicle, said window and sun shade module comprising:
a frame portion configured for mounting to a vehicle;
said frame portion including a window panel;
said frame portion including opposed channel portions that extend at least partially along and generally parallel to said window panel;
a sun shade screen, said sun shade screen including a partially translucent screen portion and opposite guide portions along opposite side regions of said screen portion; and
said guide portions of said sun shade screen being movable along said channels to move said screen portion between a shielding position, where said screen portion is positioned at least partially along said window panel, and a retracted position, where said screen portion is not positioned along said window panel.

23. The window and sun shade module of claim 22, wherein said screen portion comprises a flexible screen that is movable between said shielding position and said retracted position.

24. The window and sun shade module of claim 22, wherein said sun shade screen is retractable within a housing portion, said housing portion being substantially encapsulated by said frame portion.

25. The window and sun shade module of claim 22, wherein said sun shade screen includes a grasping portion along an edge region of said sun shade screen, said grasping portion being configured for a user to grasp to move said sun shade screen along said at least one channel.
